(19) United States
(12) Patent Application Publication
(10) Pub. No.: US 2001/0037400 A1
(43) Pub. Date: Nov. 1, 2001

(54) Method and system for decreasing the user-perceived system response time in web-based systems

(76) Inventors: Uri Raz, Fairlawn, NJ (US); Yehuda Volk, Tel-Aviv (IL); Shmuel Melamed, Ramat-Gan (IL)

Correspondence Address: Clifford Chance Rogers & Wells LLP, 200 Park Avenue, New York, NY, 10166-0153, US

(21) Appl. No.: 09/747,260

(22) Filed: Dec. 22, 2000

Related U.S. Application Data
(63) Continuation-in-part of application No. 09/120,575, filed on Jul. 22, 1998.
(60) Provisional application No. 60/177,444, filed on Jan. 21, 2000.

(51) Int. Cl. G06F 15/16

(52) U.S. Cl. 709/232

(57) ABSTRACT

In an improved method and system for decreasing the user-perceived system response time when accessing web sites, the server is configured to service the initial web page request and then identify a set of N web site elements which are likely to be subsequently requested by the client. This set of resources is then streamed to the client. When the server determines that the client has accessed a sufficient number of the streamed elements or reached another threshold, a subsequent set of N site elements is identified and streamed to the server.

### CROSS-REFERENCE TO RELATED APPLICATIONS

This application claims priority under 35 U.S.C. § 119 from U.S. Provisional Application Ser. No. 60/177,444 entitled “Method and Apparatus for Improving the User-Perceived System Response Time in web-Based Systems and filed on Jan. 21, 2000, the entire contents of which is hereby expressly incorporated by reference.

This application is a continuation-in-part of U.S. Application Ser. No. 09/120,575 entitled “Streaming Modules” and filed Jul. 22, 1998. The entire contents of these parent application is hereby expressly incorporated by reference:

### FIELD OF THE INVENTION

The present invention is related to a method and system for decreasing user-perceived system response time in web-based systems and, more particularly, to an improved method and system for decreasing user perceived response time to view Internet web-page contents and embedded and referenced functionality.

### BACKGROUND

In a client-server environment, such as widely present on the Internet, client users access and utilize information stored on the server systems. Internet-based data is commonly stored and referenced in web pages using a hypertext markup language (HTML) which is interpreted by appropriate web browsing software resident on the client system. A web page can include formatted or predefined data contents and can also reference resources, such as software modules or other functionality which is automatically retrieved by the web browser or which is retrieved through the action of the web page contents itself, such as resources retrieved by executable code embedded in the web page.

Often, a web page will contain many embedded resources and reference or link to many more. In order for a user to fully access the page, a large amount of data must be transferred to the client system. Because of the relatively slow download speed of many Internet connections, it can take an unacceptable long time for a complex page to fully download to the client system. Further, certain resources may not be required until after the user makes a given selection on the page. To reduce initial download time, the page may be constructed so that these resources are only downloaded after the relevant selection has been made. However, this can also reduce added delays after the selection is made and reduce the overall system response time as perceived by the user.

Several techniques have been employed to increase the speed with which web pages are displayed to a user upon request. The most common of which is the use of a client-side caching mechanism which stores downloaded data. Once a user has accessed a given page of data, on a subsequent access of the page, some or all of the page can be retrieved from the cache without need to again download the complete page from the server. As will be appreciated, the cache is not effective the first time a page or any of the linked pages or resources are visited.

A conventional system which is used to improve apparent response time is commonly referred to as net accelerator. When a client initiates a session with a server and accesses a given page of a multi-page web site, a net accelerator residing on the server sends all of the pages in the web site to the client. These pages are then stored in the client cache. When the user requests a different page in the web site, the browser can retrieve the web page from the local cache rather than fetching it the web site server. In a variation of this technique, accelerator software can reside on the client which operates to fetch all pages in a web site from the server when the client first accesses a given page. In either system, after all of the pages have been transferred to the client and cached locally, the subsequent user-perceived response time of the system for displaying pages from the web site is increase since the pages have already been transferred.

Although simple to implement, there are significant disadvantages to this technique. In particular, because all the pages of the web site are sent to the client, network resources are heavily taxed. In addition, the resources of the server and the client, such as processor and memory resources, are also stressed as multiple web pages and associated resources are accessed, transferred, and stored.

An alternative technique for improving the performance of a web site is to provide a network of cache servers. Such a technique is employed by Akamai Technologies, Inc., of Cambridge, Mass. In the Akamai technique, cache servers are placed in the network and are linked to the web page host servers. Each cache server has a number of corresponding clients. Each time a new web page (i.e., a web page that has not been previously accessed by any of the clients corresponding to the particular cache server) is accessed by a client corresponding of the particular cache server, the cache server downloads that page from the web site, stores the page, and serves the page to the client. When another client connected to the cache server accesses the same page, it is retrieved from the networked cache instead of the primary web page host.

This network caching technique reduces average delays associated with sending web pages to clients by decreasing the apparent network distance from the client to the server. It also reduces the resources on the principal server needed for serving web pages of a site to clients since many of the requests are processed by the cache server. However, the Akamai technique does not provide a substantial benefit with respect to web sites that are not popular. Since these pages receive a relatively small number of hits, pages from such web sites are less likely to be available on the cache servers.

In addition, this caching technique is limited to static web pages and does not adequately decrease the response time associated with non-static web pages, such as pages which include browser-supported user input mechanisms or request supplemental resources. Thus, the Akamai technique does not improve the user-perceived performance of the system relating to the execution of executable code associated with web pages.

Moreover, in the Akamai system, the cache server rather than the web site server is in control of the interactions between the client and the web site server. In at least some cases, it may be more preferable to have the web site server control interactions between itself and the client.

Accordingly, there is a need for an improved technique for decreasing the user perceived response time when accessing a web page which addresses pages with embedded and referenced functionality and which also does not unduly stress the resources of the network, server, or client.

### SUMMARY OF THE INVENTION

These and other needs are met by the methods and systems of the present invention in which streaming software present on web page server and distributed to the clients is used to determine what elements of a web page are likely to be used by a client and stream those resources to be cached on the client system in advance of a specific request by the user. As the user accesses streamed elements, this information is communicated to the server. When a predetermined portion of the streamed resources have actually been accessed by client, or when the client requests other resources which have not been streamed, a subsequent determination is made as to which additional resources are likely to be needed and those resources are forwarded to the client. For resources which can be accessed by visible elements, such as links or buttons, visual indicia can be used to communicate to the user whether resources, data, etc. needed to access that element have been streamed and are already resident in the local cache. for decreasing the user-perceived system response time in web-based systems.

In one embodiment of the invention, a system includes a web site server and a plurality of clients coupled to the web site server by a network. The web site server comprises a streaming application with functionality to determine likely requests by the client accessing the web site on the server and the resources associated with the likely requests by the client. Suitable streaming software is provided to stream identified resources to the client, preferably in compressed form. Additional functionality is provided to monitor client usage of the streamed elements in order to determine when it is appropriate to stream an additional set of resources.

In a second embodiment of the invention, the system comprises a web site server and a separate streaming server connected to the web site server by a network. A plurality of clients are also connected to the network and can access the web site through the streaming server. The web site server can host the resources and data for one or more web sites and multiple web site servers can be connected to the streaming server. A streaming application on the streaming server includes the web resources of one or more web sites. A streaming application executing on the streaming server determines likely requests by the clients as well as the web resources associated with those requests. The identified requests are then retrieved from the web server and streamed to the client, preferably in a compressed form.

### BRIEF DESCRIPTION OF THE FIGURES

The foregoing and other features of the present invention will be more readily apparent from the following detailed description and drawings of illustrative embodiments of the invention in which:

FIG. 1 is a schematic diagram of one embodiment of the present invention;

FIG. 2 is a block diagram of one configuration of client 120 including a streaming manager;

FIGS. 3 and 4 are flowcharts showing the operation of the client and server in one implementation of a method for streaming static web pages to the client in accordance with the invention;

FIG. 5 is an illustration of user interface module pre-processing partitioning;

FIGS. 6 and 7 are flowcharts showing the operation of the client and server in one implementation of a method for active web pages and web site resources to the client in accordance with the invention; and

FIG. 8 is a schematic diagram of a second embodiment of the present invention.

### DETAILED DESCRIPTION OF THE PREFERRED EMBODIMENT(S):

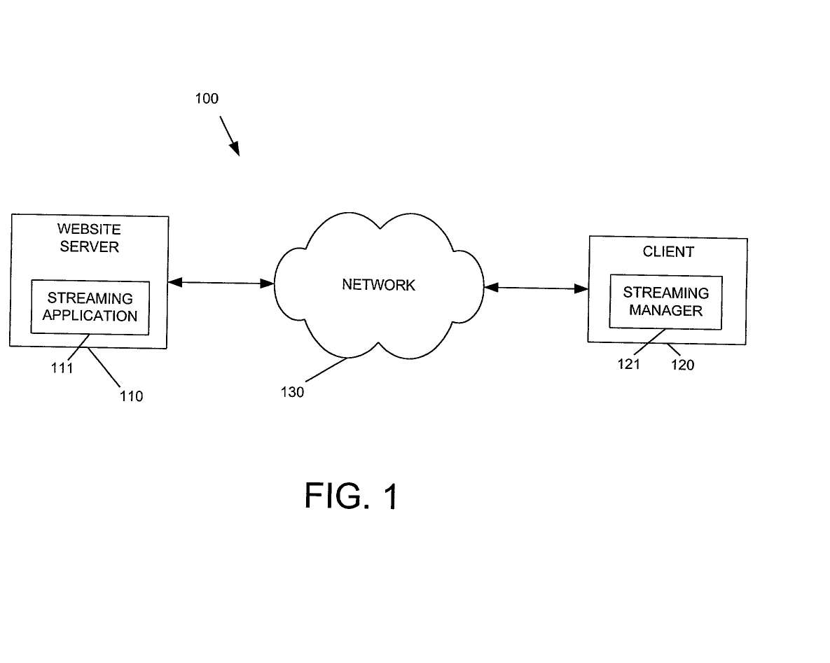

Turning to FIG. 1, there is shown a schematic diagram of one embodiment of the present invention. A system 100 comprises web site server 110 and a client 120 coupled to the server 110 via network 130, such as the Internet. The system 100 of the present invention can be used to improve the user-perceived performance of the web site server 110 in serving the client 120 with static web pages, non-static web pages, and native applications. For the purpose of clarity, system 100 is shown as including only one web site server 110 and one client 120. However, those skilled in the art will realize that the system 100 may include a plurality of web site servers 110 and a plurality of clients 120 coupled to the network 130.

In addition to hosting the web site, web site server 110 also executes a streaming application 111. A primary purpose of streaming application 111 is to anticipate or predict which web resources the client 120 is likely to request from the web site server 110 and to forward those resources to the client 120.

Various statistical techniques can be used to determine the order in which various elements referenced in a web site are likely to be accessed by a user and determine the next N most likely elements to be needed in view of presently accessed elements and possibly the current position of a user in the web page. In one embodiment, usage of the web page is analyzed and this data used to generate a predictive knowledge base. Such a knowledge base can be viewed as a graph where each node is a user selection of a particular element in the page, and an edge is the calculated probability that such a request will be made. Nodes can be associated with the specific elements needed to satisfy the given request. By examining the links flowing from a given node, the system can easily determine the most likely future requests and, thus, which elements will be needed to satisfy those requests. The predictive graph of usage probabilities can be updated continuously in response to actual use of the web site by multiple clients. In addition, various nodes can be grouped together to simplify the overall predictive model, e.g., by combining nodes which always follow each other in the overall flow of the graph.

As will be recognized by those of skill in the art, various techniques for selecting which elements are mostly likely to be needed by a client can be used. For example, a neural network can be configured to predict elements likely to be needed by a given user and trained using sequences of client accesses to a web page generated by capturing actual data or using testing methodologies. Other techniques can also be used and the specific prediction technique utilized is not critical to the invention.

As is explained in greater detail below, when a client 120 first accesses web site server 110, the streaming application 111 sends a streaming manager 121 to client 120. The streaming manager 121 is installed in the client system and coordinates communication with the streaming application 111 in the server 110.

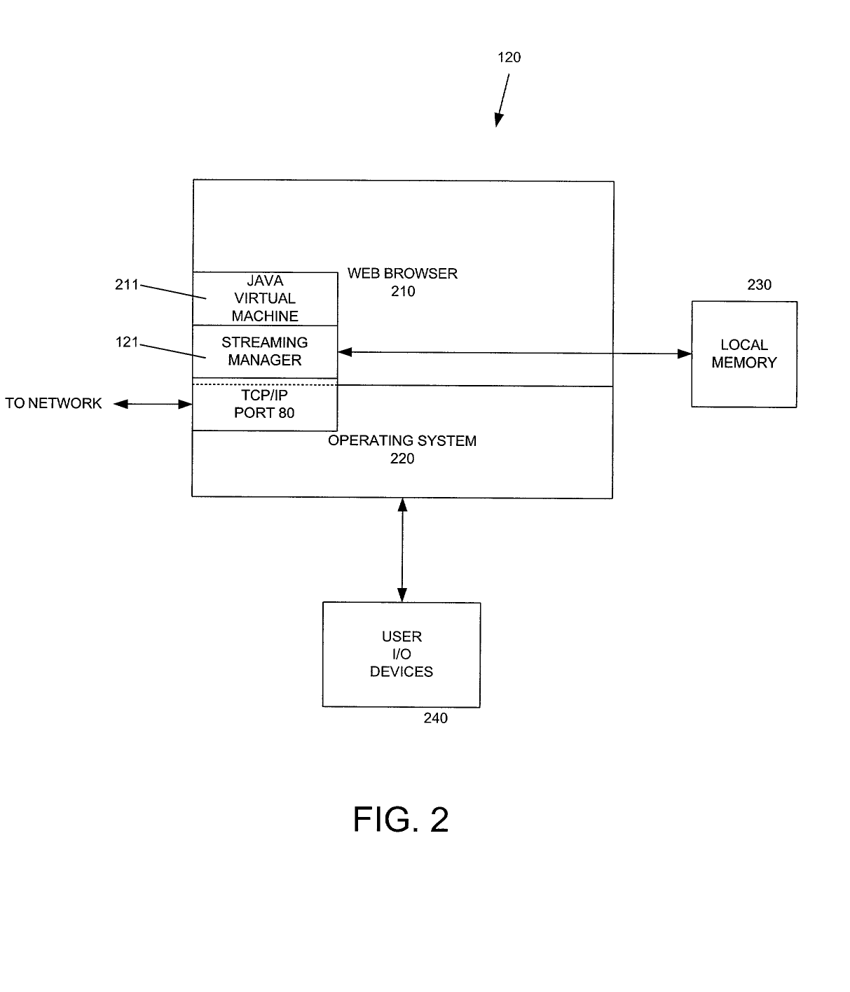

FIG. 2 is a block diagram of one configuration of client 120 after it has received the streaming manager 121. A typical client environment comprises a web browser 210, an operating system 220, local memory 230, and input/output (I/O) interface devices 240. The web browser 210 can also include a Java Virtual Machine (JVM) 211 and various other elements, such as plug-in applications.

In a conventional Microsoft-Windows based platform, access to the network is maintained through a data port, typically TCP/IP port 80. Other data conduits can also be provided. Operating system 220 contains facilitation components of the TCP/IP port 80 and at least portions of the TCP/IP port functionality are available to the web browser 210.

The streaming manager 121 is configured to controls the storage and retrieval of data from a local memory 230. According to one aspect of the invention, the streaming manager 121 includes functionality to intercept communications between the web browser 210 and the network port. Various techniques for intercepting data input and output are known to those of skill in the art and any suitable technique can be employed. Received web resources can be cached in the local memory 230 and data being fetched from the server by the browser 210 can be extracted from the local memory if available.

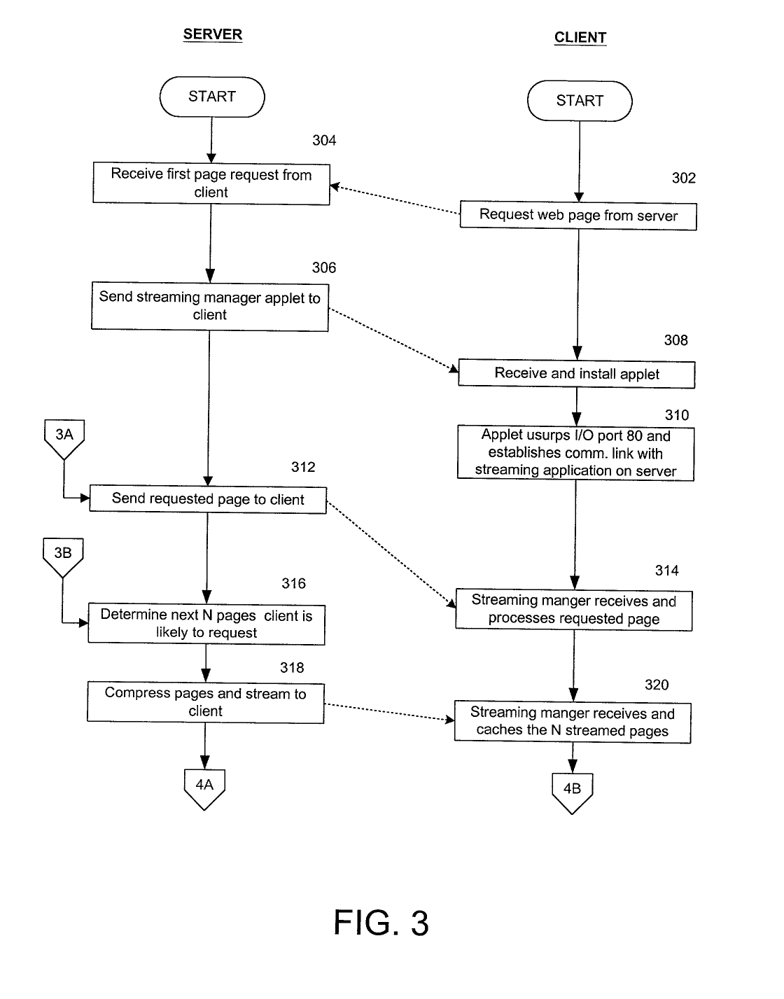

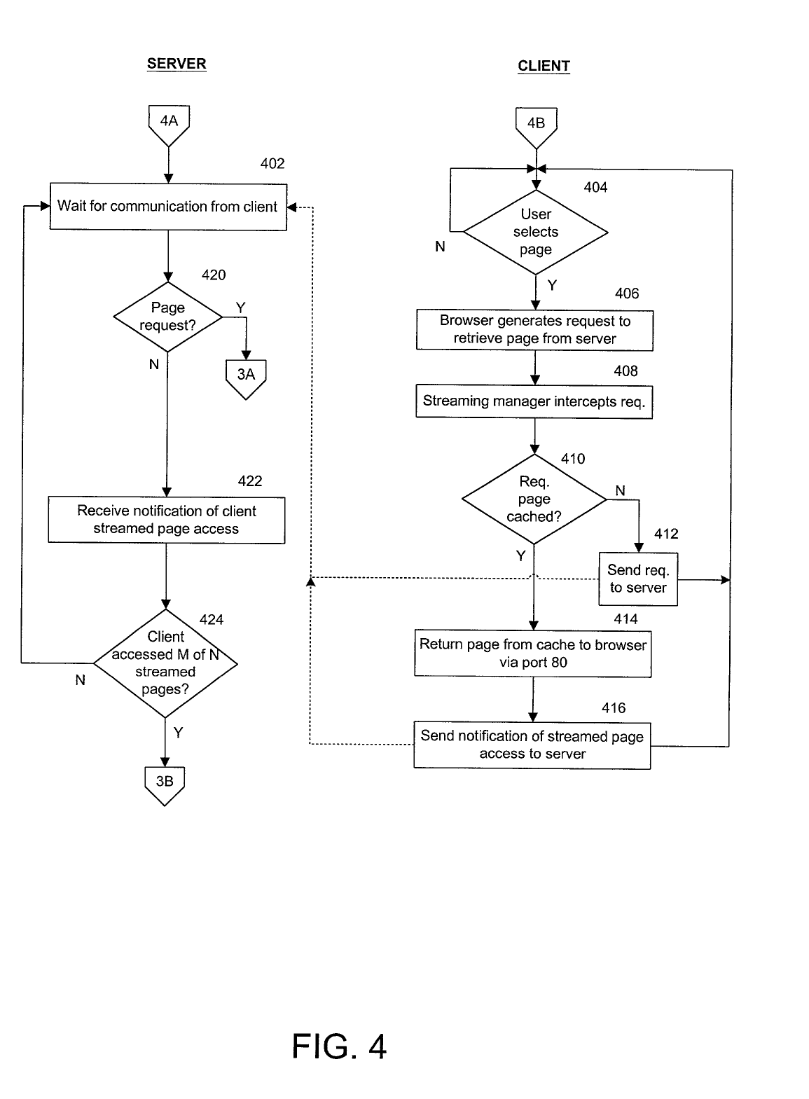

FIGS. 3 and 4 are flowcharts showing the operation of the client and server in one implementation of a method for streaming static web pages to the client in accordance with the invention. With reference to FIG. 3, initially a client makes a first request or access to a web page from the server (step 302). When a first page request is received from the client at the server (step 304), the streaming manager program is forwarded to the client (step 306). In a preferred embodiment, the streaming manager is configured as a software applet which can execute on the client system and which has access to local system resources, such as a cache memory buffer.

When the streaming manager applet is received, the client installs it as appropriate and then executes the software. As discussed above, the streaming manager intercepts the network I/O port used by the browser to access network. After a successful installation, the streaming manager accesses the I/O port and establishes communication with the streaming application on the web site server. (Step 310).

Once the streaming manager has been installed, the server sends the initially requested web page to the client (step 312). At step 308, the web site server sends the requested web page to the client via the streaming manager 121. It should be noted that transmission of the web page can alternative precede or occur simultaneously with the transmission of the streaming manager to the client. Moreover, when the client receives a requested web page, it caches the requested web page in the local memory 230. Depending on implementation, and particular when the server streaming application 111 is operating independently of other aspects of the server, when the server sends a requested web page to the client, a suitable notification can be provided to the streaming application for use, e.g., in determining appropriate pages, etc. to stream to the client.

After the requested page has been sent to the client, the streaming application 111 determines the next N web pages that the client is likely to request (step 316). N is an integer greater than one and, in one specific embodiment, is 10. The determination can be made by a predictive engine which uses a statistical model of the order in which the web page is typically accessed by various users. The streaming application then prepares the identified pages for transmission if necessary, preferably by compressing the pages. The pages are then streamed to the client (step 318). The streaming manager subsequently receives the N web pages and caches them in the local memory 230. (Step 320).

With reference to FIG. 4, once the initial page has been served to the client and the N identified pages have been streamed, the server waits to receive a subsequent communication from the client (step 402). Meanwhile, the client web browser 210 waits for a user's selection of a particular web page to visit (e.g., by selecting a link). (Step 404). When a selection is made, standard functionality in the web browser generates a request for the web page which is directed to the server. (Step 406). This request, which is directed to the port, is intercepted by the streaming manager 121 (step 408).

The streaming manager then determines if the requested web page is stored in local memory 230 or if it needs to be retrieved from the server. (Step 410). If the web page is not stored in local memory 230, such as can occur if the user selects a page which was not among the N pages streamed to the client from the server, then a request for the page is forwarded to the server. (Step 412).

The server, upon receiving a communication from the client (step 402) determines if the request is for a page. (Step 420). If so, the requested page is returned to the client (step 312). The streaming application on the client receives notification that a particular web page was sent to the client and uses this information regarding the location of the user in the web site to determine a subsequent set of N pages the client is likely to request (step 316), which pages are retrieved and sent to the user and processed by the streaming manager on the client as discussed above. If the initial set of N pages has not been completely streamed to the client, streaming of the pending pages can be interrupted and those pages previously queued up to be sent to the client are replaced with or placed behind the new set of N pages to be streamed.

On the client, the streaming manager can alternatively determine that the requested web page is cached in local memory 230. If so, the requested page is retrieved from the cache and returned to the browser (step 414). Preferably, the requested data is returned via the port 80 functionality in the browser such that it appears that the page was returned by the server and the operation of the streaming manager is transparent to the client. In other words, from the perspective of the web browser, it appears that the requested web page was directly received from the network over port 80 instead of the local memory 230. In addition, the streaming manager sends a notification to the server that the streamed resource has been accessed. (Step 416).

According to a particular aspect of the invention, the server monitors the usage of streamed pages by the client and streams additional pages only when it is determined that they are likely to be needed. This determination can be made by considering the number of streamed pages used by the client and comparing this to a threshold value. Advantageously, this scheme permits the server to remain one-step ahead of the needs of the client while minimizing the amount of network and other resources used at any given time.

Returning to FIG. 4, when the server receives a streamed page access notification from the client or, more generally, a notification that other streamed resources, such as objects linked to a streamed page, have been accessed, the server processes the communication (steps 402, 420, 422) and determines whether the client has accessed M of the N web pages streamed to the client, where the threshold value M is an integer less than or equal to N. For example, for a value N=10, the threshold M can be set to 5. In another embodiment, M and/or N may have other values, which values can change dynamically, for example, in response to system usage. If the threshold number of streamed pages or resources have not been accessed by the client (step 424), the server continues to wait for additional communications from the client. The server can log the use of the particular resource by the client and use this information, for example, to revise the predictive model. If the number of pages accessed by the client has reached the defined threshold value of M (step 424), then the server determines the next set of N pages likely to be used by the client (step 316) based on the position of the client in the web site and the process continues.

Preferably, the pages which are transmitted are compressed for transmission to reduce bandwidth requirements and decompressed by the streaming manager. Associated content linked to or referenced by the pages can also be compressed for delivery. In a further preferred embodiment, the N web pages are sent to the client as a package, rather than individually. Because each network session involves the creation of a communication link between the client and server for sending material from the server to the client, sending the N pages as a package utilizes less resources then executing N separate transmissions.

In a second embodiment of the present invention, the streaming system is configured to stream non-static web pages and their associated resources from a web site server to a client. The streaming operation generally remains the same. However, certain advantages can be obtained by pre-processing various code resources, such as Java applets, which require a user interface.

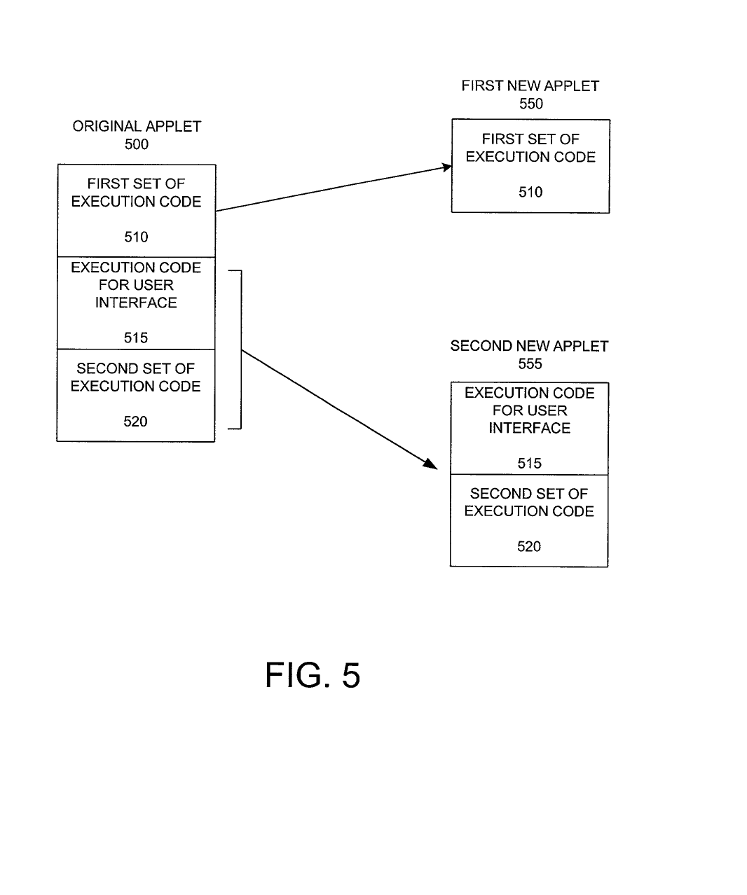

FIG. 5 schematically illustrates the pre-processing partitioning of the present invention. In FIG. 5, an original applet 500 includes a first set of executable code 510, executable code 515 for effecting user interface, such as a user input or changing the screen display, and a second set of executable code 520. Executable code 515 can include the first instance in original applet 500 of an instruction for effecting a user interface.

In the partitioning process, the executable code 515 for effecting user interface is treated as a breakpoint for a new object class. The first set of executable code 520 which precedes the executable code 515 for effecting user interface is treated as a first new applet 550. The executable code 515 for effecting a user interface and the second set of executable code 520, which follows it, are treated as a second new applet 555. Thus, two applets are created from the original, where the first new applet 550 comprises the first set of executable code 510 and the second new applet 555 comprises the executable code 515 for effecting user interface and the second set of executable code 520.

If the original applet were streamed to a user, the entire applet would need to be transferred before execution could begin. Advantageously, the partitioning illustrated in FIG. 5 allows execution of the first executable code module without waiting for a user interface to be transferred. The second new applet 555, on the other hand, is executed as part of the process of displaying its associated web page by the browser. As a result, the user interface activity of the second new applet 555 takes place in an appropriate context. It is to be noted that the execution of the second new applet 555 generally starts only after the execution of the first new applet 550 is completed. Functionality can be included in the streaming manager 121 to prevent execution of the second new applet 555 before execution of the first new applet 550 is completed.

The partitioned classes can be stored at the web site server 110. When the original class is to be sent to the client from the web site server, the partitioned classes are sent instead. When the partitioning occurs during preprocessing, the user does not experience delays associated with partitioning the original classes. Original applet classes which do not include code for effecting a user interface are preferably not partitioned into new classes. However, other breakpoints can be used to divide applets into smaller components which can execute independently of each other.

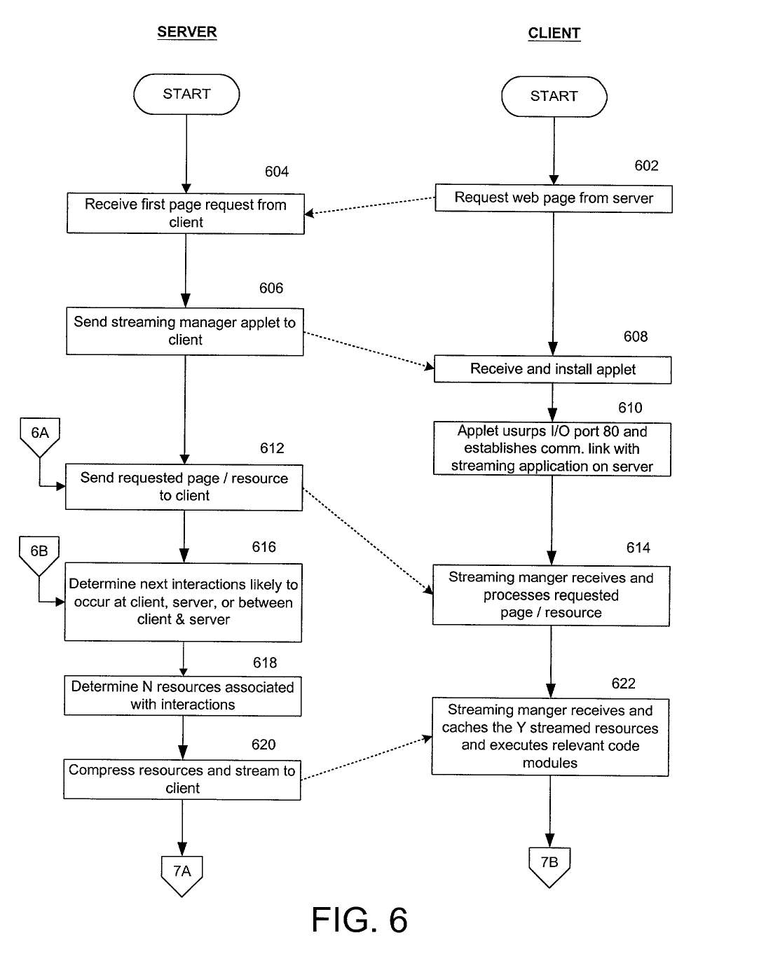

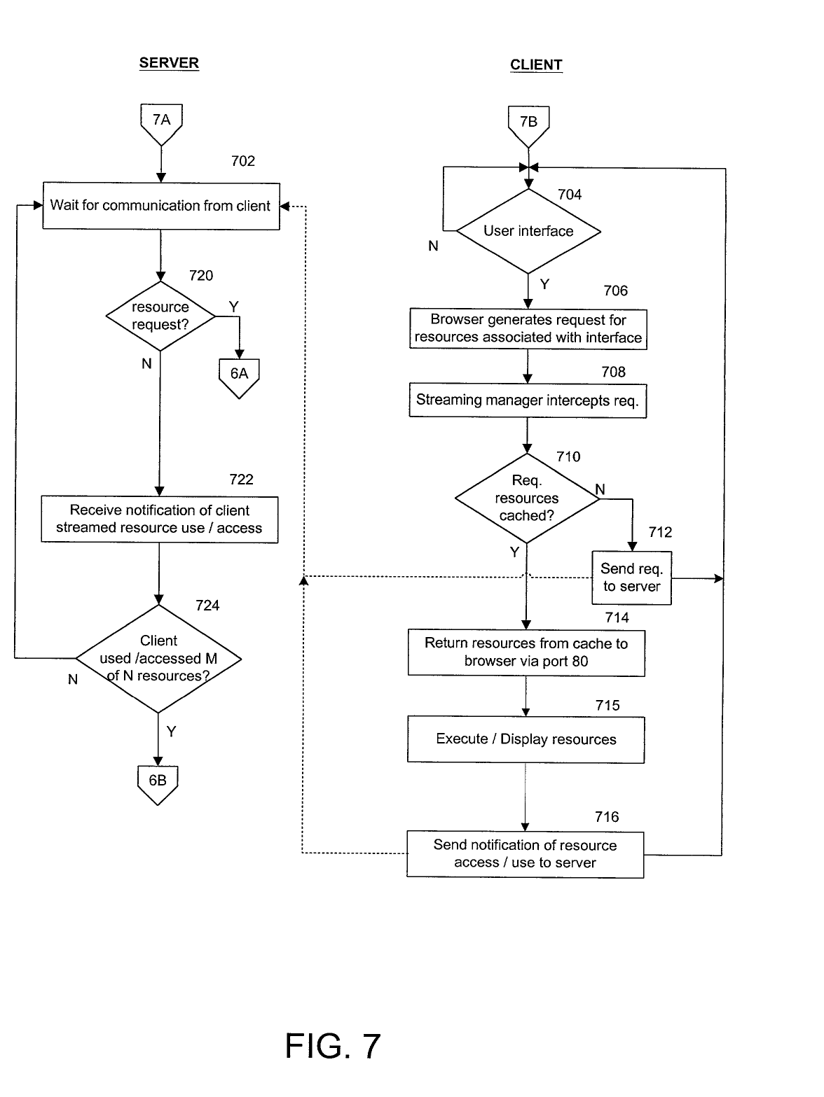

FIGS. 6 and 7 are flowcharts showing the operation of the client and server in one implementation of a method for streaming non-static web pages to a client. For clarity, this embodiment is discussed separately from the static-page streaming embodiment of FIGS. 3 and 4. However, and as will be understood by those of skill in the art, the embodiments can be combined to provide a system which streams both static and non-static pages. Alternatively, the two embodiments can operate simultaneously to stream static and non-static elements. In general, when the resources associated with the interactions are limited to those of static web pages, the methods of FIGS. 6 and 7 reduce to those of FIGS. 3 and 4.

Turning to FIG. 6, the initial process of receiving a first request from the client, installing the streaming manager on the client, and sending the initial page or resource (steps 602-614) parallels the initial steps 302-314 of FIG. 3. It should be noted, that the first request refers to the first request, in a web browsing session, from the client to the web site server. Thus, if the request in step 302 is a request after the first request, but is the first request for a non-static web page in the web browsing session, the streaming manager does not need to be installed on the client. It is also to be noted that the requested web page of step 608, unlike that of step 308, may have associated therewith web resources comprising executable code modules. The executable code modules (both those that include code for effecting a user interface and those that do not) associated with the web page are executed by the browser or associated software as part of the process of displaying the web page at the client.

Rather than determining the next series of pages which the client is likely to request, the streaming application, determines the next series of interactions which are likely to occur at one or more of the client, the web site server, or between the client and the web site server. (Step 616). The streaming manager then determines the N resources associated with those likely interactions (step 618). The resources associated with the identified interactions can be any type of web resources, including supplemental resources. Various techniques for determining the likely actions to be taken by a user of a web site and identifying the resources needed to respond to those actions will be known to those of skill in the art and are generally an extension of the static page prediction techniques.

Once a set of N resources has been identified, the resources are (preferably) compressed and then streamed to the client (step 620). As the streaming manager receives the N streamed resources, they are stored in the local cache. In addition, if executable code modules have been provided, they can be executed upon receipt if appropriate. (Step 622).

Many modules which are streamed to the client include classes of executable code which does not contain executable code for effecting a user interface. Modules of this type can be created as the first portions of partitioned executable code modules (e.g., first new applet 550) during the partitioning preprocessing. Relevant executable code modules can also include unpartitioned executable code modules which do not include code for effecting a user interface.

In the above executions, if the executed code is the first portion of partitioned executable code modules (e.g., the first new applet 550), then the results of the execution can be stored in the local memory 230 and the results made available for further processing or display, if any, during execution of the second portions of partitioned executable code modules (e.g., the second new applet 555).

The execution of the second portions of partitioned executable code modules (e.g., the second new applet 555) occurs as part of displaying the associated web page. If the associated web page for a second portion of a partitioned executable code is the web page requested by the client, then that code is executed as part of the process of displaying the requested web page of step 608. However, if the associated web page for a second portion of a partitioned executable code is other than the requested web page, execution of the code is deferred until the associated web page is requested and displayed.

As will be appreciated, certain code modules can reference supplemental resources, including additional executable code module associated with the requested web page or a different web page, and which may or may not contain code for effecting a user interface. These supplemental resources can be treated in a manner similar to the directly referenced resources. Because the references to these resources might not be apparent from a review of the web page source itself, additional steps may be required during preprocessing to properly identify all of the resources which are required to display and process the various pages in a web site.

Although the resources are generally to be executed by the client, the N resources can also include results generated by, at least partly, executing code at the web site server 110. Thus, in such a case, the executable code is executed by the web site server 110 to generate the resource in question.

Turning to FIG. 7, after the resources are streamed to the client, the server enters a wait state. (Step 702). The client system waits for a user interface condition to occur in the web browser (step 704), such as a user response to a query generated by executable code or for filling a form. The user interface can also be data provided by the browser without any direct input from the user, for example, a cookie. If there is no user interface, then the web browser continues to wait for a user interface until the browsing session is terminated or a user interface is provided.

If there is a user interface the web browser generates a request to port 80 for the web resources associated with the user interface (step 706). This request is intercepted by the streaming manager (step 708) which subsequently determines if the needed resources are present in local memory (step 710). If the web resources are not stored in local memory 230, then a request for the resource is sent to the server (step 712). Upon receipt of such a request (steps 720), the server returns the resource to the client (step 612) which executes the resource and/or displays the requested web resources. The server also identifies a subsequent set of N resources to send to the client and streams those in a manner similar to that discussed above for static pages. (Steps 616-620). If the resource requested by the browser is present in local memory, then the resources are returned to the browser by the streaming manager (step 714) and are executed or displayed as appropriate (step 715). In addition, a notification that the streamed resource has been used is sent to the server. (Step 716).

The server, upon receipt of such a notification (step 722), determines whether the client has used a sufficient number of the streamed resources to meet a threshold M. If the threshold has not been met, the server can continue to monitor the client communications. If the threshold has been met (step 724), the server can then identify a subsequent set of N resources likely to be needed by the client and stream the resources accordingly. (Steps 616-620).

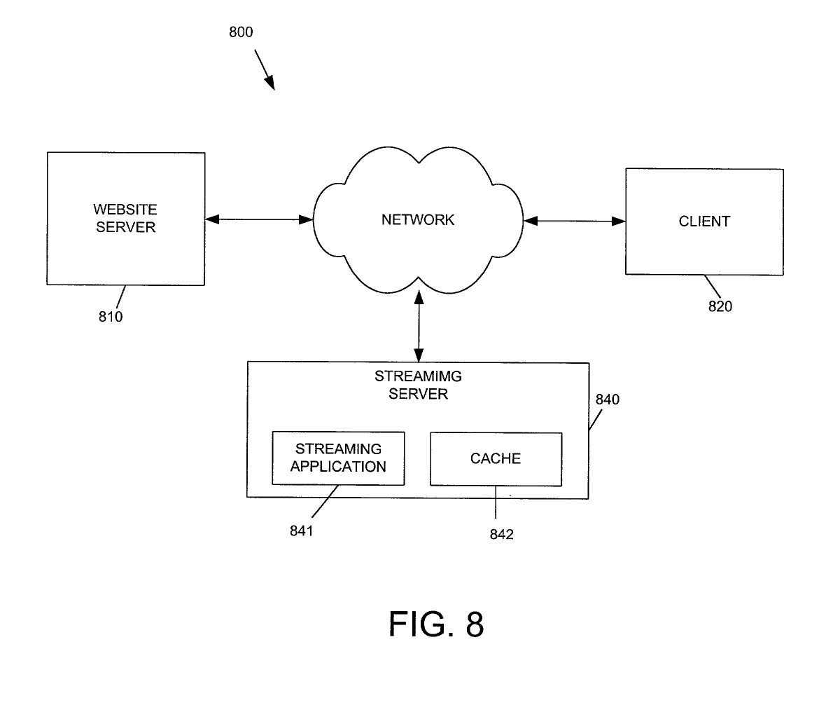

Turning to FIG. 8, there is shown a schematic diagram of another embodiment of the system of the present invention. The system 800 comprises a web site server 810, a streaming server 840, and a client 820 which are all coupled via network 830. For the purpose of clarity, system 800 is shown as including only one web site server 810, one streaming server 840, and one client 820. However, those skilled in the art will realize that the system 800 can include a plurality of web site servers 810, streaming servers 840, and clients 820. Each streaming server 840 can be associated with any one or more of the web site servers 810 coupled to the network 830. Moreover, each streaming server 840 has a number of corresponding clients 820 to which it streams web resources from web site servers 810.

Unlike web site server 110 of system 100, web site server 810 of system 800 does not include the streaming application. Instead, the separate streaming server 840 executes the streaming application 841. In a manner similar to that discussed above for the streaming application 111 embedded in the server 110, streaming application 841 running on streaming server 840 anticipates the web resources the client 820 is likely to request from the a particular web site server 810 and forwards those resources to the client 820. As can be appreciated, a single streaming server 840 can be used to provide streaming in accordance with the invention to multiple web site servers by routing the client requests through the streaming server 840.

The streaming server 840 can instruct the appropriate web site server 810 to send the designated pages and/or resources directly to the clients. Alternatively, a memory or cache 842 can be provided at the streaming server 840 to store web pages and resources that have been requested by any of the clients 820 associated with the streaming server 840. When the streaming server 840 determines that a client is likely to request a web resource that is stored in memory 842 or when a client actually requests a web resource stored in memory 842, the streaming server 840 retrieves that web resource from memory 842 and serves it to the client 820 instead of retrieving the resources from the web site server or directing the web site server to send the resources to the client. This reduces the load on a given server and also serves the function of, at least partially, mirroring web sites from which its corresponding clients 820 request web resources.

System 800 of the present invention may be used to improve the user-perceived performance of the web site server 810 in serving the client 820 with static web pages and non-static web pages.

While the invention has been particularly shown and described with reference to preferred embodiments thereof, it will be understood by those skilled in the art that various changes in form and details may be made without departing from the sprit and scope of the invention. For example, the client need not inform the streaming server each time a streamed resource has been accessed. Instead, the streaming manager on the client can monitor the number of used streamed pages or resources and determine whether the threshold for additional streaming has been reached. If so, a request can be sent to the server requesting that the subsequent N pages resources be streamed. In addition, the threshold M has been described as a count of the number of streamed pages (from among the N pages) that have been accessed by the client. In an alternate embodiment, the threshold can be access of a page number of a particular page among the N pages by the client, for example, when the web site is generally viewed in a linear sequence. Further, while the invention has been discussed with regard to streaming of web pages, the invention is not limited to use with HTML encoded pages designed for viewing over the Internet, but also can be used in other analogous network-based data delivery environments. Finally, when a page is streamed, generally all of the web page definition and contents is streamed. However, there are circumstances where it can be desirable to stream only a portion of the definition and/or contents of a page and these variations should also be considered within the scope of the present invention.

### GLOSSARY

To facilitate understanding of the present invention, a number of the terms used are defined below. These definitions are for general reference only and should not be strictly construed when considering the scope of the present invention.

User-perceived response time can be quantified as the average time between the user's request and the user's awareness that the system has completed a response to the request.

A web page resource refers to any one or more of the following: web page definitions, web page contents, and supplemental resources.

A web page definition defines the structure of a web page (e.g., the formatting used to make the desired presentation of the page to the user) and can contain, either directly or by reference, the web page contents.

web page contents encompasses both items which are displayed on a web page and executable code which can be included in the page definition or referenced in the page in a manner which permits retrieval of the code by the web browser. The web page contents are, among other things, used to manifest the web page displayed to the user.

Supplemental resources refers to resources retrieved by web page contents e.g., resources retrieved by executable code in the web page contents, as opposed to resources received by the web browser. Supplemental resources can include, for example, executable code or data requested from other web sites or databases.

A web page comprises the combination of a web page definition and the corresponding web page contents. Web pages can be characterized into two categories: static web pages and non-static web pages (which are also referred to herein as dynamic or interactive web pages).

A static web page is a web page that does not include browser-supported user input means, other than predefined link selections (i.e., hyperlinks), in its web page definition and does not include web page contents of a type capable of soliciting or responding to user input or of generating changes to the visible display of a web page. Furthermore, a static web page does not include web page contents of the type capable of requesting supplemental resources.

Any web page that is not a static web page is a non-static web page. A non-static web page includes either browser-supported user input means other than predefined link selection in its web page definition, or web page contents of a type capable of soliciting or responding to user input or of generating changes to the visible display of a web page. Furthermore, a non-static web page may include web page contents of the type capable of requesting supplemental resources.

An example of a static web page is one whose web page definition includes Hypertext Markup Language (HTML) code for rendering the web page and whose web page contents are limited to the following: text, graphics data, audio data, video data, and hyperlinks, which as is known to those skilled in the art correspond to Universal Resource Locators (URL's) to other browser-supported content, e.g., web pages, of the same or other web sites.

An example of a non-static web page is one whose web page definition may include HTML code, dynamic HTML code, Extensible Markup Language (XML) code and whose web page contents may include any of the following: Common Gateway Interface (CGI) code, script code (e.g., JavaScript), applets (e.g., Java applets) or other executable modules (e.g., Active X code) directly or by reference. The applets or other executable modules may, for example, conduct interactions between the client and the web site server. These interactions may involve responses generated by a server in response to service requests made by executable modules on the client including, for example, a server output.

1. A method of streaming web site elements from a server to a client comprising the steps of:
receiving an initial request for an element from a client;
sending the requested element to the client;
identifying a first set of N web site elements which can be requested by the client;
streaming the initial set of N elements to the client;
upon a determination that the client has accessed M of the N streamed elements, M<=N, identifying a second set of N web site elements which can be requested by the client and streaming the second set of N elements to the client.

2. The method of claim 1, further comprising the step of compressing web page elements prior to streaming the elements to the client.

3. The method of claim 1, wherein the step of determining comprises the step of receiving streamed element access notifications from the client.

4. The method of claim 1, further comprising the step of:
receiving a subsequent request for an element from the client;
sending the requested subsequent element to the client;
identifying a subsequent set of N web site elements which can be requested by the client; and
streaming the subsequent set of N elements to the client.

5. The method of claim 4, wherein the subsequent set of N elements is streamed to the client prior to other elements selected for streaming to the client but not streamed.

6. The method of claim 1, further comprising the step of sending streaming management software to the client after receipt of the initial request from the client.

7. The method of claim 6, wherein the streaming management software is configured to:
cache received elements from the server;
intercept requests from a web browser to a network port at the client;
return cached elements requested from the browser via the port; and
issue requests to the server for elements which are not in the cache.

8. The method of claim 7, wherein the streaming management software is further configured to send notification of use of streamed element by the browser to the server.

9. The method of claim 1, wherein the elements comprise static web pages.

10. The method of claim 1, wherein the element comprise web page resources.

11. The method of claim 1, wherein the elements comprise executable code modules, the method further comprising the steps of:
partitioning an interface code module comprising a first set of code, user interface code, and a second set of code into a first new module comprising the first set of code and a second new module comprising the user interface code and the second set of executing code;
streaming the interface code module to the client as the first new module and the second new module.

12. The method of claim 11, wherein the partitioning step is performed prior to initiation of a session with the client.

13. A method of streaming web site elements from a web site server to a client comprising the steps of:
receiving at a streaming server an initial request from a client for an element on the web site server;
instructing the web site server to send the requested element to the client;
identifying a first set of N web site elements which can be requested by the client from the web site server;
instructing the web site server to stream the initial set of N elements to the client;
upon a determination that the client has accessed M of the N streamed elements, M<=N, identifying a second set of N web site elements which can be requested by the client and instructing the web site server to stream the second set of N elements to the client.

14. The method of claim 13, wherein the step of determining comprises the step of receiving at the streaming server streamed element access notifications from the client.

15. The method of claim 13, further comprising the step of:
receiving at the streaming server a subsequent request for an element from the client;
instructing the web site server to send the requested subsequent element to the client;
identifying a subsequent set of N web site elements which can be requested by the client; and
instructing the web site server to stream the subsequent set of N elements to the client.

16. The method of claim 15, further comprising the step of instructing the web site server to stream the subsequent set of N elements to the client prior to sending other elements to the client.

17. The method of claim 13, further comprising the step of sending streaming management software from the streaming server to the client after receipt of the initial request from the client.

18. A system for streaming web site elements to a client comprising:
a web site server having the web site stored thereon, the web site comprising a plurality of elements;
a streaming application configured to, upon receipt of an initial request for an element from a client:
cause the requested element to be sent to the client;
identify a first set of N web site elements which can be requested by the client;
cause the initial set of N elements to be streamed the client; and
upon a determination that the client has accessed M of the N streamed elements, M<=N, identify a second set of N web site elements which can be requested by the client, and cause the second set of N elements to be streamed to the client.

19. The system of claim 18, wherein the web page elements are compressed prior to streaming the elements to the client.

20. The system of claim 18, wherein the streaming application is further configured to receive streamed element access notifications from the client.

21. The system of claim 18, wherein the streaming application is further configured to, upon receipt of a subsequent request for an element from the client:
cause the requested subsequent element to be sent to the client;
identify a subsequent set of N web site elements which can be requested by the client; and
cause the subsequent set of N elements to be streamed to the client.

22. The system of claim 21, wherein the streaming application is further configured to cause the subsequent set of N elements to be streamed to the client prior to other elements selected for streaming to the client but not streamed.

23. The system of claim 18, wherein the streaming application is further configured to send streaming management software to the client after receipt of the initial request from the client.

24. The system of claim 23, wherein the streaming software contains computer instructions to configure the client to:
cache received web site elements;
intercept requests from a web browser for web site elements;
return cached elements requested from the browser; and
issue requests to the web site server for elements which are not in the cache.

25. The system of claim 24, wherein the streaming software contains additional computer instructions to configure the client to send notification of use of streamed element by the browser to the web site server.

26. The system of claim 18, wherein the elements comprise static web pages.

27. The system of claim 18, wherein the element comprise web page resources.

28. The system of claim 27, wherein the elements comprise executable code modules, the streaming application further configured to:
partition an interface code module comprising a first set of code, user interface code, and a second set of code into a first new module comprising the first set of code and a second new module comprising the user interface code and the second set of executing code; and
cause the interface code module to be streamed to the client as the first new module and the second new module.

29. The system of claim 18, further comprising:
a streaming server in communication with the web site server and the client; the streaming application comprising being executed by the streaming server.

30. The system of claim 29, wherein the streaming sever further comprises a cache, the streaming server being configured to cache web page elements sent from the web server to the client and service client requests for web page elements present in the streaming server cache.

31. A method of streaming web resources from a web site to a client comprising the steps of:
(a) receiving a request from a client for a static web page on a web site;
(b) sending the client the requested static web page;
(c) determining a set of N next static web pages that the client will likely request;
(d) streaming the N static web pages to the client;
(e) upon receipt of a notification that the client has reached a threshold M of use of the N static web pages, continuing from step (c); and
(f) upon receipt of a user requests for a static web page not among the N static web pages, continuing from step (b).

32. The method of claim 31, further comprising the step of compressing static web pages prior to the streaming step.

33. The method of claim 31, wherein the threshold M comprises a count of the number of pages from among the N pages that have been accessed by the client.

34. The method of claim 31, wherein the threshold M comprises a use of a particular page among the N pages.

35. A method of streaming web resources from a web site to a client comprising the steps of:
(a) receiving a request from a client for a resource from the web site;
(b) sending the client the requested resource;
(c) determining interactions that are likely to occur at at least one of the client, the web site server, and between the client and the web site server;
(d) determining a set of N resources associated with the determined interactions;
(e) streaming the N resources to the client;
(f) upon receipt of a notification that the client has reached a threshold M of use of the N resources, continuing from step (d); and
(g) upon receipt of a user requests for a resource not among the N resources, continuing from step (b).

36. The method of claim 35, further comprising the step of compressing resources prior to the streaming step.

37. The method of claim 35, wherein the threshold M comprises a count of the number of resources from among the N resources that have been accessed by the client.

38. The method of claim 35, wherein the threshold M comprises access to a specific resource from the N resources.

39. A computer program product for use in streaming lements from a server to a client comprising computer code to configure the server to:
receive an initial request for an element from a client;
send the requested element to the client;
identify a first set of N web site elements which can be requested by the client;
stream the initial set of N elements to the client;
upon a determination that the client has accessed M of the N streamed elements, M<=N, identify a second set of N web site elements which can be requested by the client and stream the second set of N elements to the client.

40. The computer program product of claim 39, further comprising computer code to configure the server to compress web page elements prior to streaming the elements to the client.

41. The computer program product of claim 39, further comprising computer code to configure the server to receive streamed element access notifications from the client.

42. The computer program product of claim 39, further comprising computer code to configure the server to:
receive a subsequent request for an element from the client;
send the requested subsequent element to the client;
identify a subsequent set of N web site elements which can be requested by the client; and
stream the subsequent set of N elements to the client.

43. The computer program product of claim 39, further comprising computer code to configure the server to stream the subsequent set of N elements to the client prior to other elements selected for streaming to the client but not streamed.

44. The computer program product of claim 39, further comprising computer code to configure the server to send streaming management software to the client after receipt of the initial request from the client.

45. The computer program product of claim 39, wherein the streaming management software comprises computer code to configure the client to:
cache received elements from the server;
intercept requests from a web browser to a network port at the client;
return cached elements requested from the browser via the port; and
issue requests to the server for elements which are not in the cache.

46. The computer program product of claim 45, wherein the streaming management software further comprises computer code to configure the client to send notification of use of streamed element by the browser to the server.

47. The computer program product of claim 39, wherein the elements comprise one of static web pages and web page resources.

48. The computer program product of claim 39, wherein the elements comprise executable code modules, the computer program product further comprising computer code to configure the server to:
partition an interface code module comprising a first set of code, user interface code, and a second set of code into a first new module comprising the first set of code and a second new module comprising the user interface code and the second set of executing code;
stream the interface code module to the client as the first new module and the second new module.

49. A computer program product for use in improving a perceived response time at a client requesting web elements from a web site server, the computer program product comprising computer code to configure a streaming server to:
receive an initial request from a client for an element on the web site server;
instruct the web site server to send the requested element to the client;
identify a first set of N web site elements which can be requested by the client from the web site server;
instruct the web site server to stream the initial set of N elements to the client;
upon a determination that the client has accessed M of the N streamed elements, M<=N, identify a second set of N web site elements which can be requested by the client and instruct the web site server to stream the second set of N elements to the client.

50. The computer program product of claim 49, further comprising computer code to configure the streaming server to:
receive a subsequent request for an element from the client;
instruct the web site server to send the requested subsequent element to the client;
identify a subsequent set of N web site elements which can be requested by the client; and
instruct the web site server to stream the subsequent set of N elements to the client.

51. The computer program product of claim 50, wherein the computer code configures the streaming server to instruct the web site server to stream the subsequent set of N elements to the client prior to sending other elements to the client.
